(19) United States
(12) Patent Application Publication
(10) Pub. No.: US 2005/0062242 A1
(43) Pub. Date: Mar. 24, 2005

(54) Knee wheels

(76) Inventor: Brad Stone, Red Deer (CA)

Correspondence Address: Brad Stone, 20 Fairway Avenue, Red Deer, AB, T4N 4Y8, CA

(21) Appl. No.: 10/656,761

(22) Filed: Sep. 8, 2003

(51) Int. Cl. B62M 1/00

(52) U.S. Cl. 280/32.5

(57) ABSTRACT

A device for providing rolling mobility while kneeling or the like and comprising of a main deck of different and specific sizes, each having multiple swivel type wheels mounted on the deck underside allowing for movement in any horizontal direction and dense foam adjustable knee and shin padding system secured to the deck top side to cushion and comfort user's lower leg and optional leg straps to anchor user leg to knee wheels deck and (pending model type) an integral front mounted tool tray for working ease and a braking system to anchor “knee wheels” while stationary at specific point where work is to be performed.

### BACKGROUND OF THE INVENTION

### Prior Art

Up until now anyone who has to preform work while kneeling (Framers, finish carpenters, electricians, plumbers, tile setters, floor layers, etc.) has the option of wearing any number of different styles of knee protection to reduce physical stress of the knee. Knee pads do serve to lessen the impact of kneeling and crawling. They also serve to slow the worker and don't address other challenges that face the kneeling worker.

### SUMMARY

Through development of “Knee Wheels” we have greatly advanced the welfare of the worker.

“Knee Wheels” gives the worker the ability to roll quickly and easily from one point to another and reduces physical stress by eliminating the need to be continually standing then kneeling between work points. “Knee Wheels” are a specifically designed device for allowing the worker to remain kneeling and still be able to move efficiently from task to task.

The device comprises of specifically shaped deck type means mounted on multiple swivel wheels with extensive knee and shin padding mounted on top side of deck means to allow users a more comfortable efficient means of preforming work while kneeling. The deck kneeling profiles are designed to allow the users comfort while working and case of movement between tasks. Along with an integral front mounted tool tray to carry hand tools and small materials at the proper height where tasks are to be performed.

And finally as an added bonus, “knee wheels” can assist with moving tools on and off the jobsite

### DETAILED EMBODYMENT OF THE INVENTION

Referring to the drawings and details:

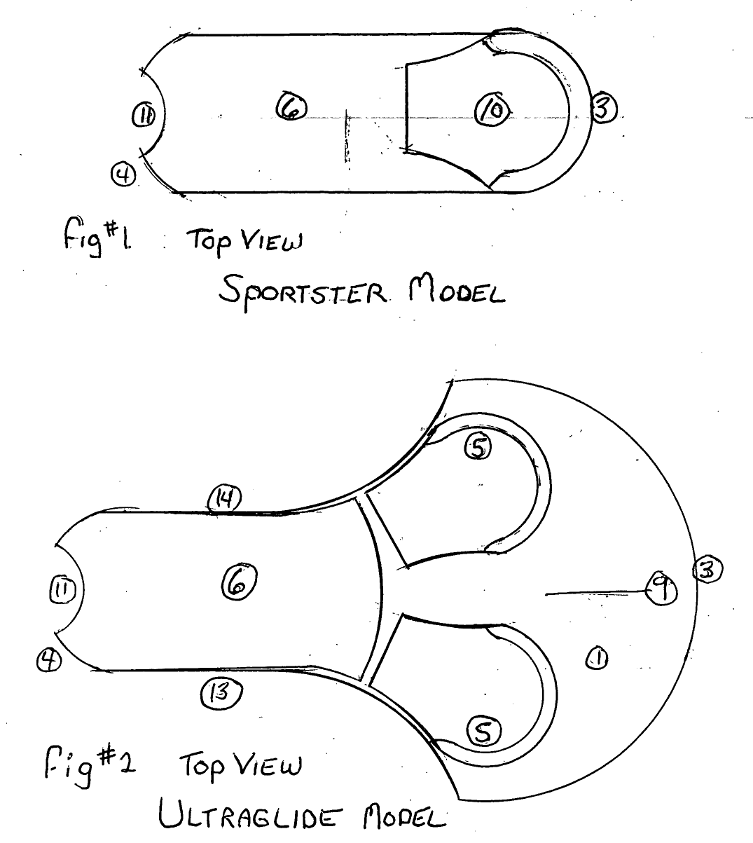

FIG. 1 shows a top view of knee wheels “sportster” model showing the knee padding (10) shin padding (6) and foot notch (3).

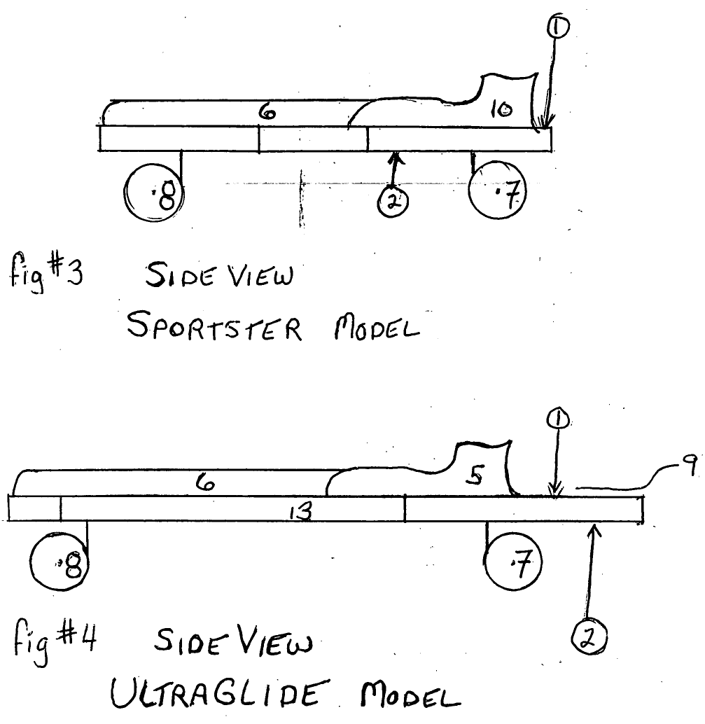

FIG. 3 shows a side view of Deck means with swivel wheels mounted to deck underside (2) and knee padding (10) and shin padding (6) mounted on deck top side (1).

Knee wheels “sportster” are able to be used for 1 leg only while the other leg is used to push sportster model along, allowing user to remain kneeling. We also recommend a separate knee pad for the pushing leg while stationary.

FIG. 2 shows a top view of Knee Wheel “Ultra-Glide” model showing two knee pads (5) and shin padding (6), a rear foot notch (11) and the front Tool tray portion (9) of the main deck means.

FIG. 4 shows a side view of Knee wheels “Ultra-Glide” Deck means with swivel wheels front (7) and swivel wheels rear (8) mounted to Deck underside (2) and knee padding (5) and shin padding (6) mounted to deck top side (1) and tool tray (9) on front (3) of deck means.

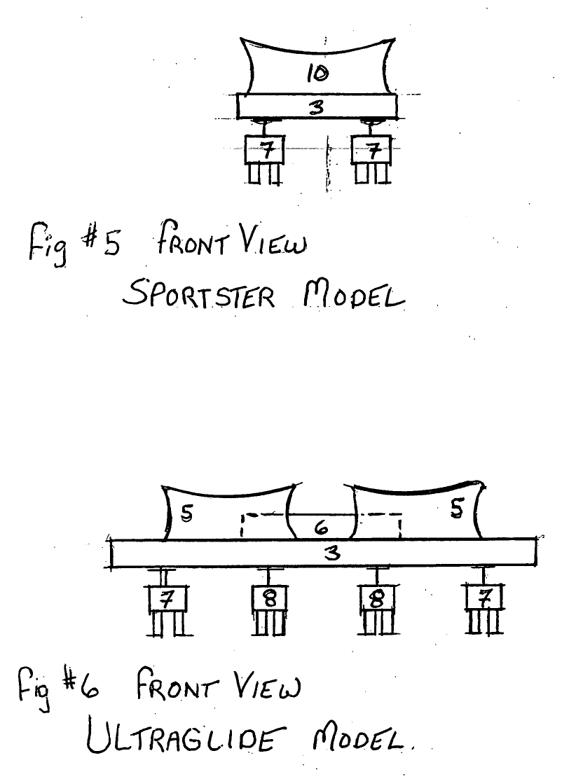

FIG. 5 (“sportster”) and FIG. 6 (“Ultra-Glide”) show front view of Knee wheel devices showing knee pads (5) on deck top side (1) and swivel wheels on deck underside (2).

Drawings

FIG. 1—Top View Sportster model
2—Top View Ultra-Glide model
3—Side View Sportster model
4—Side View-Ultra-Glide model
5—Front View Sportster model
6—Front View Ultra-Glide model

Item #1) Deck top side
2) deck under side
3) Knee wheel front
4) Knee wheel rear
5) Knee padding (Ultra-Glide model)
6) Shin padding foam
7) Swivel wheel front
8) Swivel wheel rear
9) Tool tray (Ultra-Glide model) portion of deck single
10) Knee padding (sportster model)
11) Foot notch rear
12)
13) Deck right hand side
14) Deck left hand side

1. What is claimed is a devise to provide rolling mobility while kneeling or the like and comprising of a deck specifically shaped to enhance user ease with swivel type wheels or castors mounted on the deck underside along with said braking device means and a proper foam padding system means with adjustable front knee paddings and permanently mounted dense foam shin padding mounted on deck top side and either with or without integral front mounted tool tray and/or detachable leg straps.
